(19) United States
(12) Patent Application Publication
(10) Pub. No.: US 2005/0286093 A1
(43) Pub. Date: Dec. 29, 2005

(54) Image drawing apparatus and image drawing method

(75) Inventors: Katsuto Sumi, Kanagawa-ken (JP); Kazuteru Kowada, Kanagawaken (JP); Issei Suzuki, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/154,945

(22) Filed: Jun. 17, 2005

(30) Foreign Application Priority Data
Jun. 17, 2004 (JP) 179586/2004

(51) Int. Cl. H04N 1/04

(52) U.S. Cl. 358/474

(57) ABSTRACT

In an image drawing apparatus and an image drawing method for multiple-overlay image drawing, uneven density and resolution caused by an error of installation angle of an image drawing head and by pattern distortion can be reduced. A rectangular two-dimensional pixel array is installed in each of exposure heads in an exposure apparatus (image drawing apparatus) so as to make a predetermined angle with the scanning direction, facing an exposure surface. Slits and photo detectors detect in the exposure surface an actual installation angle of a representative light-spot column near the center of the pixel array. Active pixels in the pixel array are selected so as to realize multiple-overlay exposure ideally by causing overexposure and underexposure to be minimal in an area near the representative light-spot column, based on the measured angle. Exposure is carried out by causing only the active pixels to operate.

### BACKGROUND OF THE INVENTION

1. Field of the Invention

The present invention relates to an image drawing apparatus and an image drawing method. More specifically, the present invention relates to an image drawing apparatus and an image drawing method for forming a two-dimensional pattern represented by image data on an image drawing surface by multiple-overlay image drawing.

2. Description of the Related Art

There are known various kinds of image drawing apparatuses, each comprising an image drawing head for forming a desired two-dimensional pattern represented by image data on an image drawing surface. As a representative example of such an image drawing apparatus, an exposure apparatus for forming a desired two-dimensional pattern on an exposure surface of a photosensitive material or the like by using an exposure head in order to generate a semi-conductor substrate or printing plate can be listed. Such an exposure head in an exposure apparatus generally has a pixel array comprising a plurality of pixels for generating light spots forming a desired two-dimensional pattern, such as a light-source array or spatial light modulators. The desired two-dimensional pattern can be formed on an exposure surface by causing the exposure head to operate with movement relative to the surface.

Recently, proposals are beginning to be made regarding exposure apparatuses that carry out exposure for a plurality of times on each point in an exposure surface. In such an exposure apparatus is used an exposure head having a pixel array including two-dimensionally arranged pixels. The exposure for a plurality of times on each point can be realized by causing a scanning line formed by a light from each of the pixels to match a scanning line formed by a light from another one of the pixels, for improving resolution or the like.

For example, U.S. Pat. No. 6,493,867 describes an exposure apparatus for improving resolution of a two-dimensional pattern formed on an exposure surface and for enabling drawing of a pattern including a smooth diagonal line. In the exposure apparatus, a rectangular digital micro-mirror device (DMD) comprising micro-mirrors laid out two-dimensionally is placed diagonally to the direction opposite to the direction of exposure surface movement (hereinafter, the direction opposite to that of exposure surface movement is referred to as the scanning direction) so that exposure spots from adjoining parts of the micro-mirrors partially overlap on the exposure surface.

Furthermore, Translation of International Patent Publication No. WO/97/034171 describes an exposure apparatus for reducing an imaging error by using a rectangular DMD placed diagonally to the scanning direction. Such imaging error is caused by drawing of a color image by changing chromaticity of resultant light generated by superposition of exposure spots on an exposure surface and caused by defect in a part of micro-lenses installed in correspondence with pixels of DMD.

Moreover, Japanese Unexamined Patent Publication No. 2004-009595 also describes an exposure apparatus for reducing uneven density in a two-dimensional pattern formed on an exposure surface, by smoothing an effect of variance in the amount of light from respective micro-mirrors with use of rectangular DMD's placed diagonally to the direction of scanning.

However, when multiple-overlay exposure is carried out by using a pixel array that has two-dimensionally arranged pixels with pixel columns placed diagonally to the scanning direction, fine adjustment is generally difficult regarding an installation angle of an exposure head including the pixel array. Therefore, a slight deviation from an ideal installation angle relative to the direction of scanning is often observed in pixel columns. Such a deviation causes density and layout of exposure spots to become different between a part of exposure surface exposed by light from some of pixels near an end of each of the pixel columns and another part in the exposure surface. Therefore, uneven density and resolution occur in a two-dimensional pattern formed by the pixel array.

In addition to the deviation of the installation angle, uneven density and resolution may also be observed in a two-dimensional pattern to be formed, due to a pattern distortion in an exposure surface caused by various kinds of aberration of an optical system between a pixel array and an exposure surface and by distortion of the pixel array itself.

In order to eliminate such unevenness, improvement can be made on accuracy in installation angle of exposure head, in pixel arrangement, and in adjustment of optical system. However, pursuing such accuracy swells manufacturing cost.

The same problem is also observed in an image drawing apparatus of other types, such as an inkjet printer comprising an inkjet recording head used for image drawing by propelling droplets of ink to an image drawing surface.

### SUMMARY OF THE INVENTION

The present invention has been conceived based on consideration of the above circumstances. An object of the present invention is therefore to provide an image drawing apparatus and an image drawing method for multiple-overlay image drawing that can reduce unevenness in density and resolution caused by an error in an installation angle of an image drawing head and by a pattern distortion.

More specifically, an image drawing apparatus of the present invention is an apparatus for forming a two-dimensional pattern represented by image data on an image drawing surface by “N-overlay image drawing” (where N refers to a natural number larger than 1), and the image drawing apparatus comprises one or more image drawing heads, moving means, active pixel specification means, and setting change means. The image drawing head or each of the image drawing heads faces the image drawing surface and comprises a pixel array having usable pixels laid out two-dimensionally and generating image drawing spots for forming the two-dimensional pattern according to the image data. The image drawing head or heads are laid out in such a manner that a direction of columns of the usable pixels forms a predetermined angle with a scanning direction of the image drawing head or heads. The moving means moves the image drawing head or heads in the scanning direction relatively to the image drawing surface. The active pixel specification means specifies, for the image drawing head or each of the image drawing heads, active pixels used for the N-overlay image drawing among the usable pixels. The setting change means changes a setting in order to cause only the active pixels to operate among the usable pixels, for the image drawing head or each of the image drawing heads.

The pixel columns in the present invention refers to lines of pixels aligned along a direction forming a smaller angle with the scanning direction, out of the two alignment directions of the two-dimensionally arranged pixels in the pixel array or arrays. “Pixel rows” refer to lines of pixels aligned along a direction forming a larger angle with the scanning direction. The pixels in each of the pixel arrays may not necessarily be placed in a rectangular grid shape. For example, the pixels may be laid out to form a parallelogram.

In the present invention, “N-overlay image drawing” refers to image drawing in such a manner that a line parallel to the scanning direction intersects with N lines of columns of the active pixels projected onto the image drawing surface in substantially all points in an image drawing area on the image drawing surface. The line intersects with the active-pixel columns in “substantially all points” in the image drawing area, since the number of the columns of the active pixels intersecting with the line parallel to the scanning direction increases or decreases slightly due to an error in an installation angle and in an installation position of the image drawing head or heads even in the case where the pixel arrays are used to complement each other in order to fill areas corresponding to both ends of each of the pixel arrays where the number of the columns of the active pixels intersecting with a line parallel to the scanning direction decreases because of diagonal arrangement of the pixel columns. Furthermore, a pixel pitch along the direction perpendicular to the scanning direction does not strictly match a pixel pitch of other parts due to an error in an installation angle or in pixel positions in a tiny area that is smaller than resolution and corresponds to each area between the columns of the active pixels. Therefore, in the tiny area, the number of the pixel columns intersecting with the line parallel to the scanning direction may change in the range of ±1. In the description below, N-overlay image drawing wherein N is two or larger is referred to as multiple-overlay image drawing. Furthermore, in an exposure apparatus or an exposure method as an embodiment of the image drawing apparatus or an image drawing method of the present invention, “N-overlay exposure” and “multiple-overlay exposure” are used as words corresponding to “N-overlay image drawing” and “multiple-overlay image drawing”.

The active pixel specification means in the present invention may receive manual specification of the active pixels. Alternatively, the active pixel specification means may comprise position detection means and selection means that will be described later for automatically selecting the active pixels optimally.

Changing the setting for causing only the active pixels to operate refers to a manner of setting the usable pixels other than the active pixels to be in an OFF state for stopping operation thereof. Alternatively, a part of the image data to be sent to the usable pixels other than the active pixels may represent data of OFF state (that is, data representing that the corresponding pixels do not participate in the image drawing). Furthermore, the setting may be changed to a state wherein an image drawing medium such as light or an ink droplet from each of the usable pixels other than the active pixels is blocked although the usable pixels other than the active pixels are actually in operation.

In the image drawing apparatus of the present invention, it is preferable for an angle θ representing the predetermined angle of the image drawing head or heads to satisfy:
sp sin θ≧Nδ
where s refers to the number of pixels forming each of the columns of the usable pixels, p refers to a pitch of the usable pixels along the direction of the pixel columns, and δ refers to a pitch of the columns of the usable pixels projected onto a line perpendicular to the scanning direction.

In the image drawing apparatus of the present invention, the active pixel specification means may specify the active pixels for each of the pixel rows.

The active pixel specification means may measure an actual installation angle formed by an actual direction of the pixel columns in the exposure surface represented by the image drawing spots and the direction of scanning, and may specify the active pixels for each of the pixel rows so as to counterbalance a deviation of the actual installation angle from the predetermined angle. In this case, the active pixel specification means may designate, as representative image-drawing spot columns, columns of the image drawing spots in the image drawing surface corresponding to some of the columns of the usable pixels, and finds an individual actual installation angle formed by a direction of each of the representative image-drawing spot columns and the direction of scanning. The active pixel specification means specifies a representative value of the individual actual installation angles as the actual installation angle. As the representative value of the individual actual installation angels can be used an average, a median, a maximum, or a minimum of the individual actual installation angles.

In the image drawing apparatus of the present invention, the pixel array or arrays of the image drawing head or heads may generate light spots as the image drawing spots. In this case, the active pixel specification means may comprise position detection means for detecting positions of the light spots in the image drawing surface for the image drawing head or each of the image drawing heads and selection means for finding, based on a result of the position detection by the position detection means, inactive pixels among the usable pixels for the image drawing head or each of the image drawing heads in such a manner that a sum of a part wherein drawing is redundant and a part wherein drawing is deficient compared to ideal N-overlay image drawing becomes minimal in a representative area including at least one area drawn by neighboring columns of the active pixels in the image drawing surface and for selecting the pixels other than the inactive pixels as the active pixels for the image drawing head or each of the image drawing heads.

Alternatively, in the case where the pixel array or arrays of the image drawing head or heads generate the light spots as the image drawing spots, the active pixel specification means may comprise position detection means for detecting positions of the light spots in the image drawing surface for the image drawing head or each of the image drawing heads and selection means for finding, based on a result of the position detection by the position detection means, inactive pixels among the usable pixels for the image drawing head or each of the image drawing heads in such a manner that the number of the image drawing spots in a part where drawing is redundant becomes the same as the number of the image drawing spots in a part where drawing is deficient compared to ideal N-overlay image drawing in a representative area including at least one area drawn by neighboring columns of the active pixels in the image drawing surface and for selecting the pixels other than the inactive pixels as the active pixels for the image drawing head or each of the image drawing heads.

Alternatively, in the case where the pixel array or arrays of the image drawing head or heads generate the light spots as the image drawing spots, the active pixel specification means may comprise position detection means for detecting positions of the light spots in the image drawing surface for the image drawing head or each of the image drawing heads and selection means for finding, based on a result of the position detection by the position detection means, inactive pixels among the usable pixels for the image drawing head or each of the image drawing heads in such a manner that a part wherein drawing is redundant compared to the ideal N-overlay image drawing becomes minimal in a representative area including at least one area drawn by neighboring columns of the active pixels in the image drawing surface while a part wherein drawing is deficient compared to the ideal N-overlay image drawing is not observed and for selecting the pixels other than the inactive pixels as the active pixels for the image drawing head or each of the image drawing heads.

Alternatively, in the case where the pixel array or arrays of the image drawing head or heads generate the light spots as the image drawing spots, the active pixel specification means may comprise position detection means for detecting positions of the light spots in the image drawing surface for the image drawing head or each of the image drawing heads and selection means for finding, based on a result of the position detection by the position detection means, inactive pixels among the usable pixels for the image drawing head or each of the image drawing heads in such a manner that a part wherein drawing is deficient compared to the ideal N-overlay image drawing becomes minimal in a representative area including at least one area drawn by neighboring columns of the active pixels in the image drawing surface while a part wherein drawing is redundant compared to the ideal N-overlay image drawing is not observed and for selecting the pixels other than the inactive pixels as the active pixels for the image drawing head or each of the image drawing heads.

The image drawing apparatus of the present invention may find the inactive pixels for each of the pixel rows.

Furthermore, in the image drawing apparatus of the present invention, the selection means may find the actual installation angle between the scanning direction and the actual direction of the pixel columns represented by the light spots projected onto the image drawing surface, based on the result of the position detection regarding at least two of the light spots found by the position detection means. Based on the actual installation angle found in this manner, the selection means finds the inactive pixels. In this case, the selection means designates, as a representative light-spot column, one of columns of the light spots formed on the image drawing surface corresponding to one of the columns of the usable pixels. The selection means finds the actual installation angle based on the result of position detection by the position detection means regarding at least two of the light spots in the representative light-spot column and the vicinity thereof. One of the light spot columns near the center thereof is preferably selected as the representative light-spot column. Alternatively, the selection means may designate, as representative light-spot columns, some of the columns of the light spots in the image drawing surface corresponding to some of the columns of the usable pixels. In this case, the selection means finds the individual actual installation angle between the scanning direction and a direction of each of the representative light-spot columns, based on the result of the position detection by the position detection means regarding at least two of the light spots in the representative light-spot columns and the vicinity thereof. The selection means can find the actual installation angle as a representative value of the individual installation angles. As the representative value of the individual installation angles can be used an average, a median, a maximum, or a minimum of the individual installation angles.

The image drawing apparatus of the present invention may further comprise reference image drawing means for carrying out reference image drawing by using only the pixels of every (N−1) columns of the usable pixels for the image drawing head or each of the image drawing heads, in order to specify the active pixels by the active pixel specification means.

Alternatively, the image drawing apparatus of the present invention may comprise reference image drawing means for carrying out reference image drawing by using only the pixels comprising a group of adjoining pixel rows corresponding to 1/N of all the rows of the usable pixels for the image drawing head or each of the image drawing heads, in order to specify the active pixels by the active pixel specification means. In the case where the number of all the rows of the usable pixels is not divisible by N, the group of adjoining pixel rows corresponding to 1/N of all the rows of the usable pixels may be a group of pixel rows corresponding to the number closest to 1/N or to the largest number smaller than 1/N, or to the smallest number larger than 1/N.

The image drawing apparatus of the present invention may further comprise data conversion means for converting the image data so as to cause a size of a predetermined portion in the two-dimensional pattern represented by the image data to match a size of a corresponding portion formed by the active pixels that have been specified.

In the image drawing apparatus of the present invention, the pixel array or arrays may be spatial light modulators that modulate light from a light source according to the image data for each of the pixels. The light source may be incorporated into the image drawing head or each of the image drawing heads (exposure head). Alternatively, the light source may be installed outside the image drawing head or heads to be used by the image drawing head or each of the image drawing heads or to be shared by a part of the image drawing heads.

In the image drawing apparatus of the present invention, it is preferable for the number N to be a natural number ranging from 3 to 7.

An image drawing method of the present invention is a method of image drawing by using one image drawing head or more facing an image drawing surface and comprising a pixel array having usable pixels laid out two-dimensionally and generating image drawing spots according to image data for forming a two-dimensional pattern represented by the image data. The image drawing head or heads are set in such a manner that a direction of columns of the usable pixels forms a predetermined angle with a direction of scanning by the image drawing head or heads. The image drawing method comprises the steps of:
specifying active pixels used for realizing N-overlay image drawing (where N is a natural number larger than 1) among the usable pixels for the image drawing head or each of the image drawing heads;
changing a setting of the image drawing head or heads so that only the active pixels to operate out of the usable pixels for the image drawing head or each of the image drawing heads; and
forming the two-dimensional pattern on the image drawing surface by causing the image drawing head or heads to operate with movement relative to the image drawing surface in the scanning direction.

Operating the image drawing head or heads with movement relative to the image drawing surface in the scanning direction refers to a manner of continuous image drawing by continuously moving the image drawing head or heads or to a manner of image drawing by moving the image drawing head or heads in a step-wise manner to a halt for drawing.

According to the image drawing apparatus and the image drawing method of the present invention, the pixels of a quantity that can minimize an effect of installation angle error of image drawing head or heads and an effect of pattern distortion are specified as the active pixels, and a filling effect of multiple-overlay image drawing can smooth a residual effect of the installation angle error and an effect of pattern distortion. Therefore, the part of redundant drawing and the part of deficient drawing can be minimized while unevenness in resolution and density in the two-dimensional pattern can be reduced in the image drawing surface.

In the case where the active pixel specification means has the position detection means and the selection means, the active pixels of a quantity that can minimize an effect of installation angle error of image drawing head or heads and an effect of pattern distortion can be automatically specified for changing the setting of the image drawing apparatus, without an operation requiring skills such as manual specification of the active pixels by an operator through confirmation of a result of reference drawing.

Furthermore, if the selection means designates the representative light-spot column and finds the actual installation angle based on the result of position detection regarding the two or more of the light spots comprising the representative light-spot column and the vicinity thereof, the selection means can select the active pixels by appropriately finding the actual installation angle even if the direction of each of the pixel columns projected onto the image drawing surface varies from column to column due to a residual effect of pattern distortion or the like. Especially, if one of the light-spot columns near the center thereof is selected as the representative light-spot column, the effect of reduction can be enhanced further in unevenness of overall resolution and density caused by the pattern distortion in the two-dimensional pattern in the image drawing surface.

In the case where the selection means designates the representative light-spot columns and finds the individual actual installation angles based on the result of position detection regarding the two or more of the light spots in the representative light-spot columns and the vicinity thereof for finding the actual installation angle, the selection means can select the active pixels by appropriately finding the representative value of the individual actual installation angles as the actual installation angle even if the direction of each of the pixel columns projected onto the image drawing surface varies from column to column due to the residual effect of the pattern distortion. In addition, the effect of reduction can be enhanced further in unevenness of overall resolution and density caused by the pattern distortion in the two-dimensional pattern in the image drawing surface.

If the reference image drawing can be carried out by using only the pixels comprising every (N-1) pixel columns, or by using the pixels in the group of adjoining pixel rows corresponding to 1/N of all the rows of usable pixels, the reference image drawing can generate a simpler pattern approximately with no overlap than a pattern by multiple-overlay image drawing. Therefore, specification of the active pixels can be easier through confirmation or the like of the pattern by an operator, which leads to easier and optimal specification of the active filling area pixels.

If the image data are converted to match the sizes of the predetermined parts, the size of the two-dimensional pattern represented by the image data can be equal to the size of the predetermined part that can be formed by the active pixels having been specified. Therefore, the two-dimensional pattern can be formed on the image drawing surface in high definition as desired.

### BRIEF DESCRIPTION OF THE DRAWINGS

FIG. 1 is a perspective view representing appearance of an exposure apparatus as an embodiment of an image drawing apparatus of the present invention;

FIG. 2 is a perspective view of the configuration of a scanner in the exposure apparatus shown in FIG. 1;

FIG. 3A is a top view representing exposed areas formed on an exposure surface of a photosensitive material while FIG. 3B is a top view showing arrangement of exposure areas of exposure heads;

FIG. 4 is a perspective view of the configuration of each of the exposure heads in the exposure apparatus shown in FIG. 1;

FIGS. 5A and 5B are a top view and a side view showing in detail the configuration of each of the exposure heads in the exposure apparatus;

FIG. 6 is a partial enlargement showing the configuration of a DMD in the exposure apparatus;

FIGS. 7A and 7B show operation of the DMD;

FIG. 8 is a perspective view showing the configuration of a fiber-array light source;

FIG. 9 is a frontal view showing layout of light emission points in a laser emission area in the fiber-array light source;

FIG. 10 shows an example of unevenness in patterns in the exposure surface caused by an error in an installation angle of the exposure heads and by pattern distortion;

FIG. 11 is a top view representing a relationship between positions of the exposure areas of the DMD and corresponding slits;

FIG. 12 is a top view for explaining a method of measuring positions of light spots in the exposure surface by using the slits;

FIG. 13 shows a state of alleviated unevenness in the pattern in the exposure surface by operating only pixels that have been selected;

FIGS. 14A and 14B show various examples of pattern distortion;

FIGS. 15A and 15B show first examples of reference exposure; and

FIGS. 16A and 16B show second examples of reference exposure.

### DESCRIPTION OF THE PREFERRED EMBODIMENTS

Hereinafter, an exposure apparatus as an embodiment of an image drawing apparatus of the present invention will be described in detail with reference to the accompanying drawings.

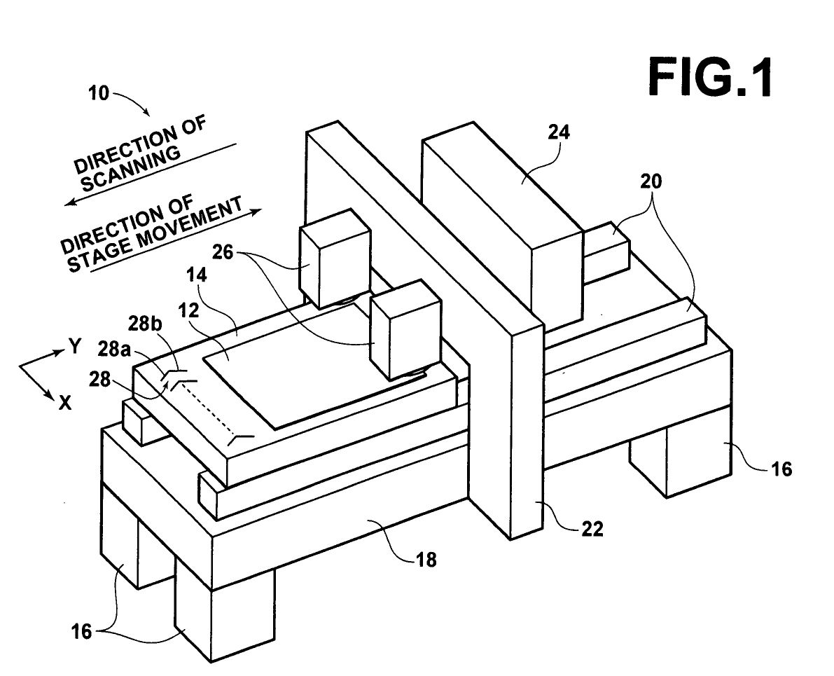

As shown in FIG. 1, an exposure apparatus 10 of this embodiment comprises a planar stage 14 for holding a sheet 12 of photosensitive material (hereinafter referred to as the photosensitive sheet 12) by suction. On the upper surface of a thick plate-like mount 18 supported by four legs 16 are placed two guide rails 20 elongated along the direction of movement of the stage 14. The stage 14 is placed in such a manner that the direction of longer sides thereof is parallel to the direction of movement thereof. The stage 14 is supported by the guide rails 20 so that the stage 14 can move back and forth along the rails. The exposure apparatus 10 also comprises a stage driving unit (not shown) for driving the stage 14 along the guide rails 20.

A U-shaped gate 22 is situated at the center of the mount 18 so as to straddle the path of the stage 14. Both ends of the U-shaped gate 22 are fixed to side faces of the mount 18. A scanner 24 is located beside the U-shaped gate 22 while a plurality (such as 2) of sensors 26 are placed opposite to the scanner 24 across the gate 22. The sensors 26 detect front and rear ends of the photosensitive sheet 12. The scanner 24 and the sensors 26 are attached to the gate 22 at fixed positions around the start of forward movement of the stage 14. The scanner 24 and the sensors 26 are connected to a controller (not shown) thereof. As shown in FIG. 1, an X axis and a Y axis that are perpendicular to each other are assumed for description, in a plane parallel to the surface of the stage 14.

On one end of the stage 14 at which scanning ends are formed ten L-shaped slits 28 placed at regular intervals. The corners of the slits are aligned along the direction of the X axis. Each of the slits 28 has a slit 28a located closer to the end of the stage 14 and a slit 28b located farther from the end. The slits 28a and 28b are perpendicular to each other in the respective slits 28, and the slit 28a forms an angle of −45 degrees with the X axis while the slit 28b forms an angle of 45 degrees. Single photo detectors (not shown) are located respectively under the slits 28 in the stage 14. Each of the photo detectors is connected to a processor (not shown) for carrying out active pixel selection processing that will be described later.

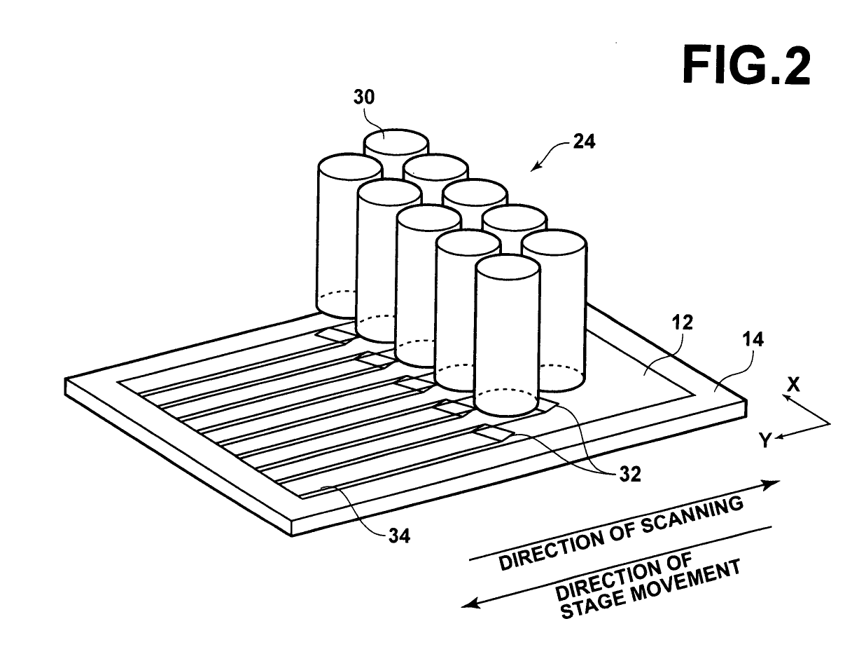

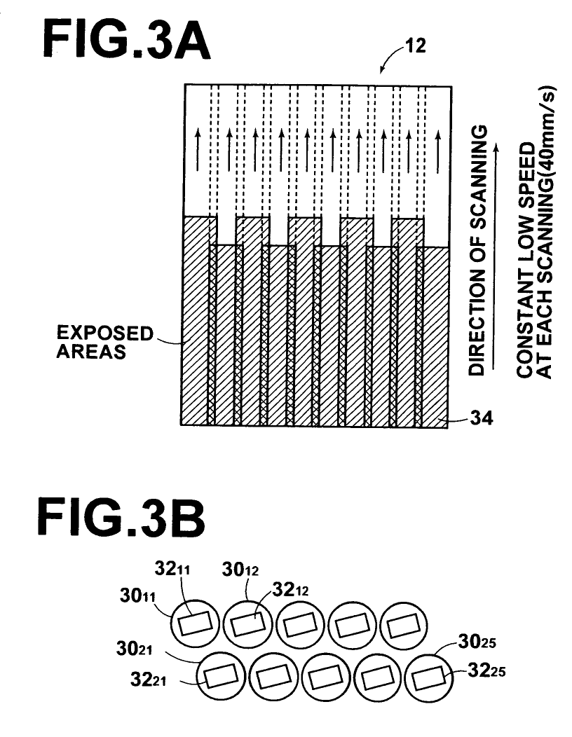

The scanner 24 comprises 10 exposure heads 30 laid out in a shape close to a matrix of 2 rows and 5 columns, as shown in FIG. 2 and FIG. 3B. Hereinafter, one of the exposure heads 30 located in an m^{th} row in an n^{th} column is expressed as an exposure head 30.

Each of the exposure heads 30 is installed in the scanner 24 in such a manner that the direction of pixel rows in a digital micro-mirror device (DMD) 36 therein forms a predetermined angle θ with the direction of scanning. Therefore, an exposure area 32 of each of the exposure heads 30 is shaped into a rectangle that is diagonal to the direction of scanning. Following the movement of the stage 14, a strip of exposed area 34 corresponding to each of the exposure heads 30 is formed on the photosensitive sheet 12. Hereinafter, an exposure area 32ₘₙ refers to an exposure area of the exposure head 30ₘₙ.

As shown in FIGS. 3A and 3B, the linearly aligned exposure heads 30 are arranged at a predetermined interval (a multiple, that is, double in this embodiment, of the longer side of each of the exposure areas) so that each of the exposed areas 34 partially overlaps with the neighboring exposed areas 34. Therefore, an area between the exposure areas 32₁₁ and 32₁₂ that cannot be exposed by the exposure heads in the first row can be exposed by the neighboring exposure area 32₂₁ in the second row.

The center of each of the exposure heads 30 substantially matches with the position of the corresponding slit 28. A size of each of the slits 28 is sufficiently large for covering a width of the exposure area 32 of the corresponding exposure head 30.

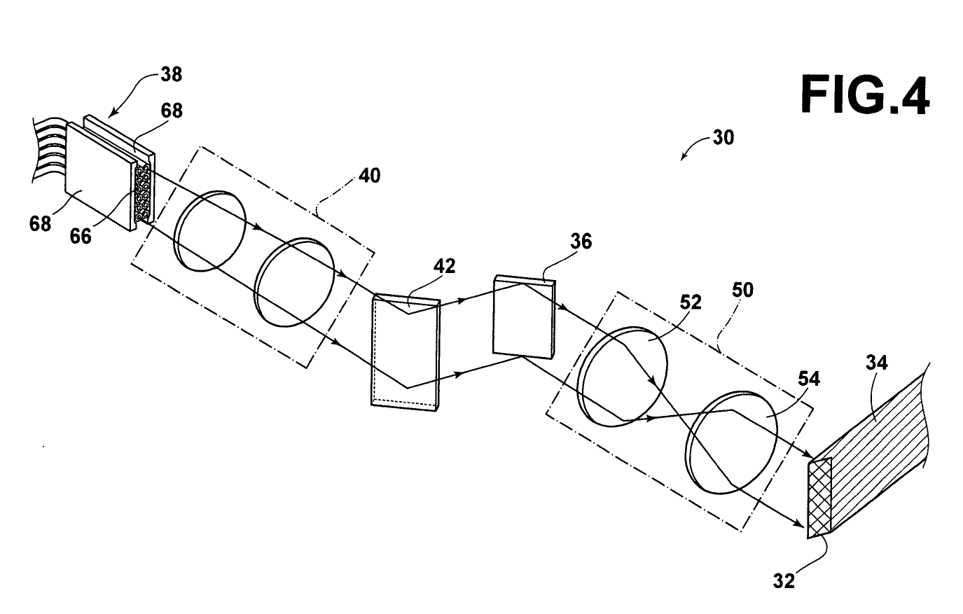

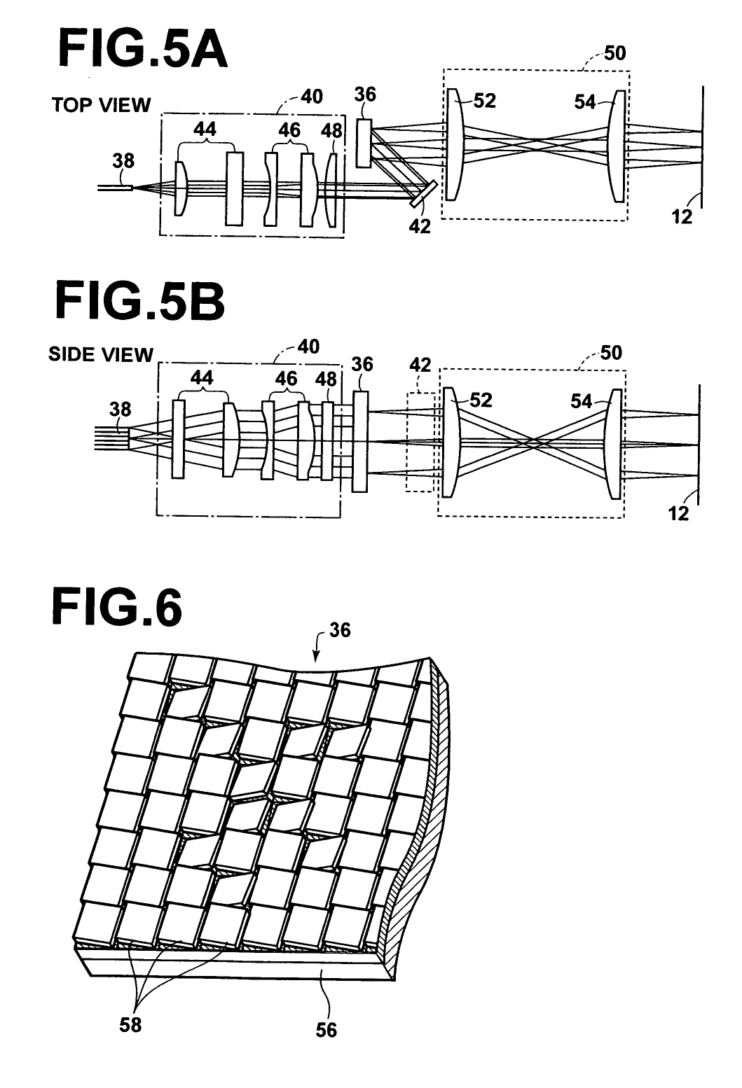

As shown in FIGS. 4 and 5, each of the exposure heads 30 comprises the DMD′ 36 manufactured by Texas Instruments Incorporated in US, as spatial light modulators for respective pixels that modulate an incident light according to image data. Each of the DMD's 36 is connected to a controller comprising a data processing unit and a mirror driving control unit. The data processing unit in the controller generates a control signal for controlling driving of each of micro-mirrors in a usable area of the corresponding DMD 36 in the corresponding exposure head 30. The mirror driving control unit controls an angle of reflection surface for each of the micro-mirrors in the corresponding DMD 36 of the corresponding exposure head 30, according to the control signal generated by the data processing unit.

As shown in FIG. 4, a fiber-array light source 38, a lens system 40, and a mirror 42 are placed in this order on one side of each of the DMD's 36 from which the light enters. The fiber-array light source 38 comprises a laser emission area in which light emission end facets (light emission points) of optical fibers are aligned along the direction of a longer side of the corresponding exposure area 32. The lens system 40 causes laser beams emitted from the fiber-array light source 38 to focus on the corresponding DMD 36. The mirror 42 reflects the laser beams having passed through the lens system 40 toward the corresponding DMD 36. In FIG. 4, the configuration of the lens system 40 is outlined.

The lens system 40, shown in FIG. 5 in detail, comprises a combination lens pair 44, a combination lens pair 46, and a condensing lens 48. The combination lens pair 44 causes the laser beams emitted from the fiber-array light source 38 to become parallel lights. The combination lens pair 46 causes the parallel lights to have uniform distribution in the amount of light. The condensing lens 48 causes the lights to focus on the corresponding DMD 36.

A lens system 50 is situated on the other side of the corresponding DMD 36 from which the reflected lights come. The lens system 50 is used for causing the reflected lights from the corresponding DMD 36 to focus on the exposure surface of the photosensitive sheet 12. The lens system 50 comprises two lenses 52 and 54 laid out in such a manner that conjugate focal planes are formed on the corresponding DMD 36 and on the exposure surface of the photosensitive sheet 12.

After the laser beams emitted from the fiber-array light source 38 are magnified by 5 times, a portion thereof from each of the micro-mirrors in the corresponding DMD 36 is narrowed to approximately 5 μm by the lens system 50.

As shown in FIG. 6, each of the DMD's 36 is a mirror device having micro-mirrors 58 comprising the pixels laid out in a grid-like pattern on SRAM cells (memory cells). In this embodiment, each of the DMD's 36 has the micro-mirrors 58 of 768 rows and 1024 columns. However, only the micro-mirrors of 256 rows and 1024 columns can be driven by the controller connected to the corresponding DMD 36 and are therefore usable. A data processing speed of the DMD's 36 is limited, and a modulation speed per line is determined according to the number of the micro-mirrors to be used. Therefore, by using only a part of the micro-mirrors, the modulation speed per line becomes faster. Each of the micro-mirrors 58 is supported by a post and the surface thereof is coated with a material having high reflectivity, such as aluminum, by vapor deposition thereof. In this embodiment, the reflectivity of each of the micro-mirrors 58 is more than 90%, and a pitch between the micro-mirrors is 13.7 μm in the horizontal direction and in the vertical direction. The SRAM cells 56 comprise CMOS'es each having a silicon gate produced in an ordinary semi-conductor memory production line with the post including hinges and yokes. The entire SRAM cells 56 are configured in a mono-lithic (unified) manner.

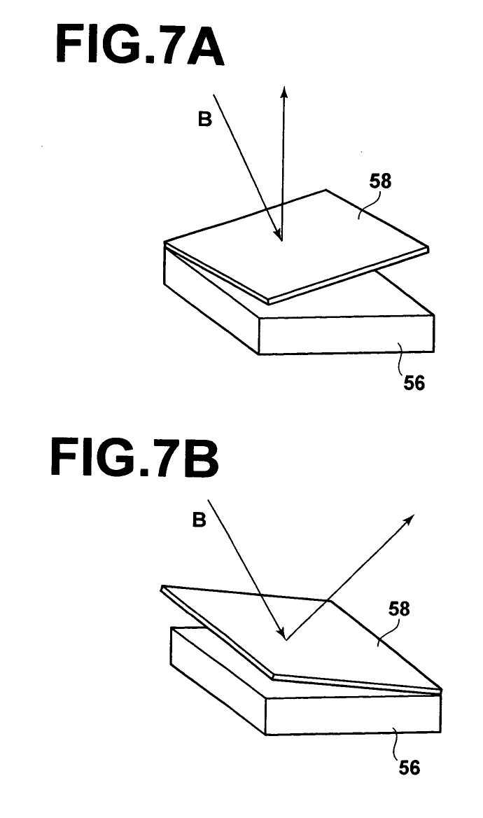

When an image signal as digital data representing density of respective points comprising a desired two-dimensional pattern is written in the SRAM cells 56 in each of the DMD's 36, each of the micro-mirrors 58 supported by the post tilts relatively to the substrate on which the corresponding DMD 36 is formed, in an angle of −α or +α degrees (such as −10 or +10 degrees) around a diagonal line thereof. FIG. 7A shows an ON state wherein one of the micro-mirrors 58 is tilted by a degrees while FIG. 7B shows an OFF state wherein the micro-mirror 58 is tilted by −α degrees. Therefore, by controlling the tilt of the respective micro-mirrors 58 at the pixels in each of the DMD's 36 according to the image signal as shown in FIG. 6, a laser beam B that has reached the corresponding DMD 36 is reflected toward the tilt of the micro-mirror 58.

FIG. 6 shows a partial enlargement of each of the DMD's 36, and represents a state wherein each of the micro-mirrors 58 is controlled to be in the tilt of −α or +α degrees. The ON or OFF state of the micro-mirrors 58 is controlled by the controller connected to the corresponding DMD 36. A light absorber (not shown) is situated in the direction of the lease beam B reflected by each of the OFF-state micro-mirrors 58.

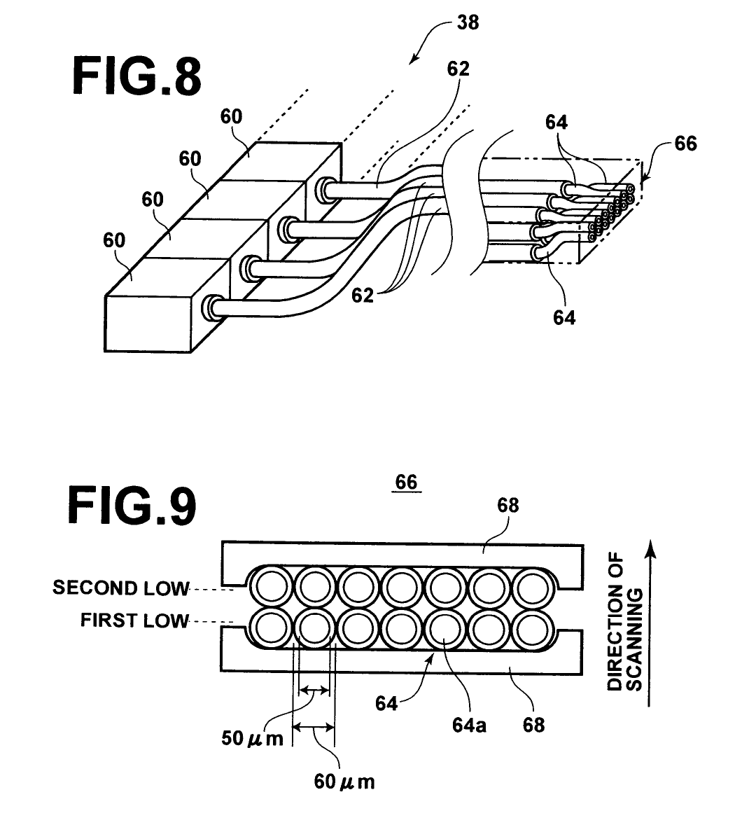

The fiber-array light source 38 comprises a plurality of laser modules 60 (such as 14 modules), as shown in FIG. 8. Each of the laser modules 60 is coupled with one end of a multiple-mode optical fiber 62. A multiple-mode optical fiber 64 having a cladding diameter smaller than that of the optical fibers 62 is also connected to the other end of each of the multiple-mode optical fibers 62. As shown in FIG. 9 in detail, a laser emission area 66 is configured by the other end of each of the multiple-mode optical fibers 64, and two lines each comprising 7 of the ends are laid out in the direction perpendicular to the direction of scanning.

The laser emission area 66 comprising the other end of each of the multiple-mode optical fibers 64 is fixed by being sandwiched with two support plates 68 each having a flat surface, as shown in FIG. 9. It is preferable for light emission end facets of the multiple-mode optical fibers 64 to be protected by a transparent plate such as glass. Since the light emission end facets of the multiple-mode optical fibers 64 tend to be degraded due to dust deposition thereon caused by high density of light, deposition of dust on the end facets and degradation thereof can be delayed by using the plate for protection.

In this embodiment, 2-overlay exposure is carried out by the exposure apparatus 10. As the predetermined angle of each of the exposure heads 30, that is, each of the DMD's 36, is adopted an angle slightly larger than an angle θ_{ideal} that realizes 2-overlay exposure by using the usable micro-mirrors 58 of 256 rows and 1024 columns in an ideal state wherein no error in installation angle or the like is found in the exposure heads 30. The angle θ_{ideal} is found by Equation (1) below:
sp sin θ_{ideal}=Nδ (1)
where N refers to the number N of N-overlay exposure, s refers to the number of the micro-mirrors 58 comprising each of pixel columns of the usable micro-mirrors 58, p is a pixel pitch in the direction of the columns of the micro-mirrors 58, and δ refers to a pixel pitch in each of the pixel columns of the usable micro-mirrors 58 projected onto a line perpendicular to the direction of scanning. Each of the DMD's 36 in this embodiment comprises the micro-mirrors 58 laid out in the form of rectangular grid whose pitches in the horizontal and vertical directions are the same, as has been described above. Therefore, Equation (2) below is satisfied:
p cos θ_{ideal}=δ (2)
Consequently, Equation (3) below can be obtained from Equations (1) and (2):
s tan θ_{ideal}=N (3)
In this embodiment, s=256 and N=2. Therefore, θ_{ideal}=0.45 degree can be found from Equation (3). Consequently, an angle such as 0.50 degree is adopted as the predetermined installation angle θ. The exposure apparatus 10 has been initially adjusted so as to cause the installation angle of the exposure heads 30 (the DMD's 36) to be close to the installation angle θ in an adjustable range.

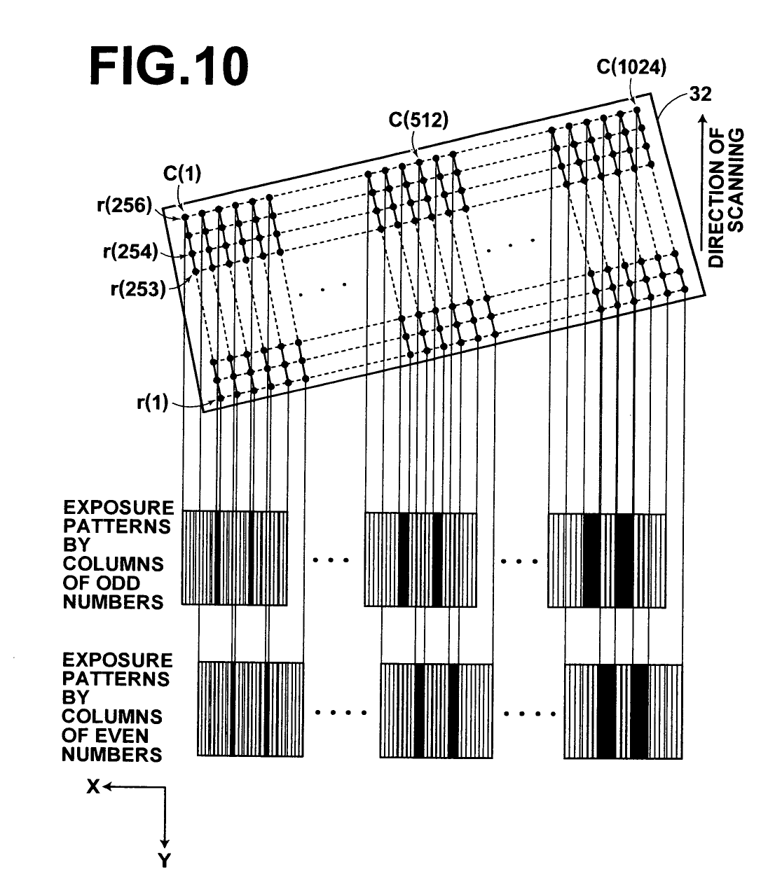

FIG. 10 shows an example of unevenness in a pattern on the exposure surface generated by the exposure apparatus 10 having been initially adjusted in the above manner, and the unevenness is generated by an effect of installation angle error of one of the exposure heads 30 and an effect of pattern distortion. In the description below, an m^{th} row of light spots in the exposure surface is referred to as r(m) while an n^{th} column of light spots in the exposure surface is referred to as c (n). A light spot in the m^{th} row in the n^{th} column is referred to as P(m,n). An upper part of FIG. 10 shows patterns of the light spots from the usable micro-mirrors 58 projected onto the exposure surface of the photosensitive sheet 12 when the stage 14 is stationary. A lower part of FIG. 10 shows exposure patterns formed on the exposure surface when the stage 14 is moved for continuous exposure in a state where the patterns shown in the upper part of FIG. 10 are formed by the light spots. For the sake of easier understanding, the exposure patterns in FIG. 10 are shown separately for the columns of the usable micro-mirrors 58 of odd numbers and for the columns of even numbers. However, the actual exposure pattern appearing on the exposure surface is a pattern generated by superposition of these patterns.

In the example shown in FIG. 10, an actual installation angle is slightly different from the predetermined installation angle θ, due to the installation angle θ being slightly larger than the angle θ_{ideal} and due to difficulty in fine adjustment of the installation angle of the exposure heads 30. Consequently, in each part in the exposure surface, exposure becomes redundant than the ideal 2-overlay exposure in areas corresponding to both ends of each of the pixel columns, that is, areas drawn by neighboring pixel columns, in the exposure patterns generated by the pixel columns of odd numbers and even numbers, generating uneven density.

Furthermore, in the example shown in FIG. 10, angle distortion as an example of pattern distortion appearing in the exposure surface is observed wherein installation angles are different between the pixel columns projected onto the exposure surface. The angle distortion is caused by various kinds of aberrations and deviation of alignment in an optical system between each of the DMD's 36 and the exposure surface, distortion of the DMD's 36 itself, and an error in installation angles of the micro-mirrors, for example. The angle distortion in FIG. 10 is one form of distortion observed when the installation angle measured from the scanning direction is smaller for the pixel columns in farther left but larger for the pixel columns in farther right in FIG. 10. As a result of the angle distortion, a width of each of the parts of redundant exposure becomes smaller toward the left but larger toward the right of FIG. 10.

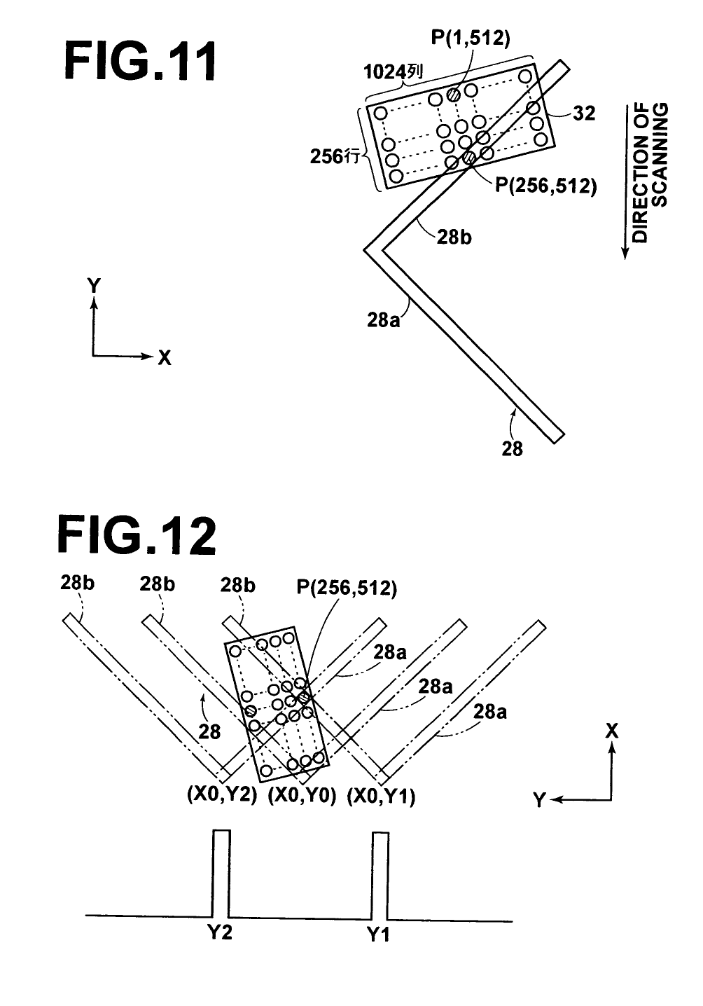

In order to reduce the unevenness in the exposure surface, the combination of the slit 28 and the photo detector described above finds an actual installation angle θ′ of the pixel columns projected onto the exposure surface for each of the exposure heads 30, and the processor connected to the photo detector carries out active pixel selection processing for selecting the micro-mirrors to be used in actual exposure, based on the actual installation angle θ′. Hereinafter, detection of the actual installation angle θ′ and the active pixel selection processing will be described with reference to FIGS. 11 and 12.

FIG. 11 is a top view showing a relationship between the position of the exposure area 32 of one of the DMD's 36 and the position of the corresponding slit 28. As has been described above, the size of the slits 28 is large enough for covering the width of the exposure area 32. In this embodiment, the 512^{th} light-spot column close to the center of the exposure area 32 is designated as a representative light-spot column, and the angle between the direction of the representative light-spot column and the scanning direction is measured as the actual installation angle θ′. More specifically, the micro-mirrors in the 1^{st} row and the 256^{th} row in the 512^{th} column in the corresponding DMD 36 are set to be in the ON state, and positions of the light spots P(1,512) and P(256, 512) corresponding to the micro-mirrors are detected. The actual installation angle θ is found as the angle between the line connecting the two light spots and the scanning direction.

FIG. 12 is a top view showing how the position of the light spot P(256,512) is detected. The stage 14 is slowly moved for causing the slit 28 to move along the Y axis while the light spot P(256, 512) is turned on. The slit 28 is positioned so as to cause the light spot P(256, 512) to come any position between the slits 28a and 28b. The coordinates of the intersection between the slits 28a and 28b are expressed as (X0, Y0). The values of (X0, Y0) are determined and recorded based on a move distance by the stage 14 to the position, which is represented by a driving signal given to the stage 14, and based on the position of the slit 28 in the X-axis direction that is already known.

Thereafter, the stage 14 is moved to cause the slit 28 to move along the Y axis to the right of FIG. 12. As shown by chain double-dashed lines in FIG. 12, the stage 14 is stopped when the light of the light spot P (256, 512) is detected by the photo detector after passing through the slit 28b on the left. The coordinates of the intersection of the slits 28a and 28b are recorded as (X0, Y1).

Thereafter, the stage 14 is moved in the opposite direction to cause the slit 28 to move along the Y axis to the left of FIG. 12. As shown by chain double-dashed lines in FIG. 12, the stage 14 is stopped when the light of the light spot P(256, 512) is detected by the photo detector after passing through the slit 28a on the right. The coordinates of the intersection of the slits 28a and 28b are recorded as (X0, Y2).

The coordinates (X, Y) of the light spot P(256, 512) are determined as:
X=X0+(Y1−Y2)/2
Y=(Y1+Y2)/2
based on the measurement described above. The coordinates of the light spot P(1, 512) are also found through the same measurement, and the actual installation angle θ′ is found as the angle between the line connecting the light spots P(1,512) and P(256, 512) and the direction of scanning.

By using the actual installation angle θ′ found in the above manner, the processor connected to the photo detector finds a natural number T close to a value t satisfying the following Equation (4):
t tan θ′=N (4)
The processor then selects the micro-mirrors from the 1^{st} to T^{th} rows in the corresponding DMD 36 as the micro-mirrors to be used for actual exposure. As the micro-mirrors to be used for actual exposure can therefore be selected the micro-mirrors causing a sum of overexposure area and underexposure area compared to ideal 2-overlay exposure to become minimal in a representative area near the 512^{th} light-spot column.

Instead of finding the natural number T close to t, a natural number closest to and larger than t may be found. In this case, the micro-mirrors to be used can be selected so that the overexposure area is caused to be minimal while the underexposure area is caused to be absent in the representative area near the 512^{th} light-spot column. Alternatively, a natural number closest to but smaller than t may be found. In this case, the micro-mirrors to be used can be selected so that the underexposure area is caused to be minimal while the overexposure area is caused to be absent in the representative area near the 512^{th} light-spot column.

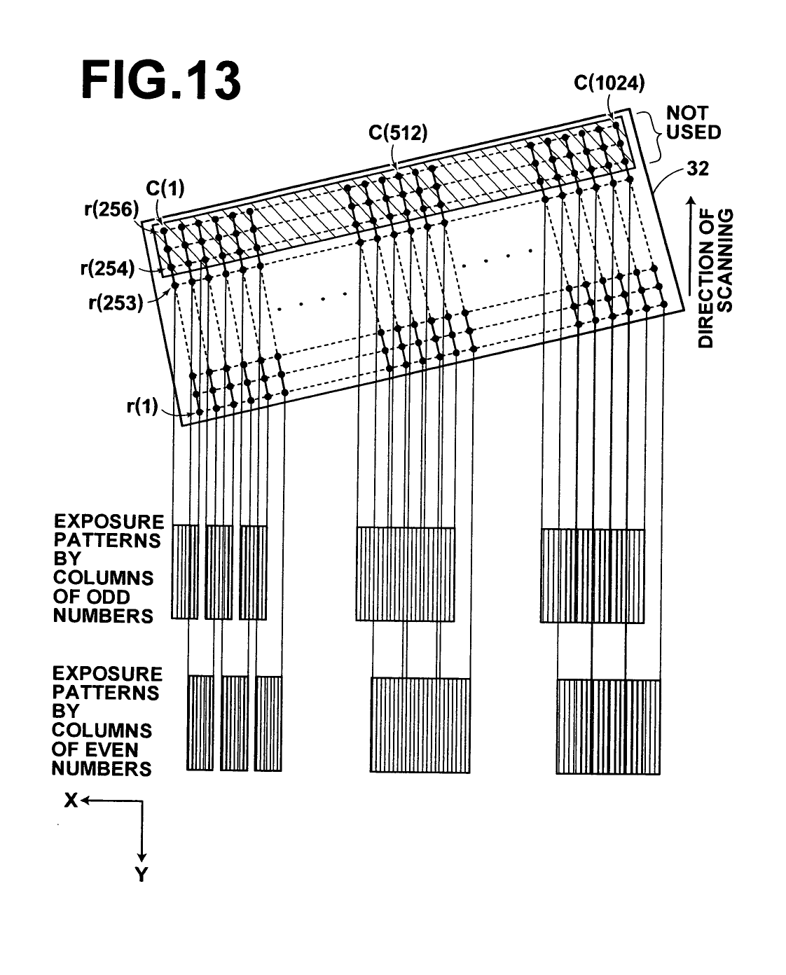

FIG. 13 shows how the unevenness in the exposure surface shown in FIG. 10 is reduced in actual exposure using only the micro-mirrors selected in the above manner as the micro-mirrors to be used. In this example, T=253 is found as has been described above, and the micro-mirrors from the 1^{st} to 253^{rd} rows are actually used for actual exposure. A signal for setting the angle of the micro-mirrors to be the angle of OFF state is sent to the micro-mirrors from the 254^{th} to 256^{th} rows, and the micro-mirrors are not used for actual exposure.

In this embodiment, the 512^{th} column of the light spots is used as the representative light-spot column for measurement of the actual installation angle θ′, as has been described above. Based on the actual installation angle θ′, the micro-mirrors 58 to be used for actual exposure are selected according to Equation (4). Therefore, as shown in FIG. 13, overexposure and underexposure in the areas drawn by neighboring pixel columns near the 512^{th} light-spot column is almost completely eliminated, and uniform 2-overlay exposure close to the ideal state can be realized.

In the left of FIG. 13 (on the side of c(1) in FIG. 13), the angles of the light-spot columns in the exposure surface are smaller than the angles near the center, due to the angle distortion described above. Therefore, in exposure using the micro-mirrors that have been selected according to the actual installation angle θ′ found with reference to the 512^{th} light-spot column near the center, tiny underexposure areas are observed among the areas drawn by neighboring pixel columns in the exposure patterns generated by the pixel columns of odd numbers as well as the exposure patterns generated by the pixel columns of even numbers, as shown in FIG. 13. However, in an actual exposure pattern generated by superposition of these patterns, the underexposure areas are complemented each other, and the effect of angle distortion can be smoothed by an effect of filling by the 2-overlay exposure.

In the right of FIG. 13 (on the side of c(1024) in FIG. 13), the angles of the light-spot columns in the exposure surface are larger than the angles near the center. Therefore, in exposure using the micro-mirrors that have been selected according to the actual installation angle θ′ measured with reference to the 512^{th} light-spot column near the center, tiny overexposure areas still remain among the areas drawn by neighboring pixel columns, as shown in FIG. 13. However, in the actual exposure pattern generated by superposition of the exposure patterns formed by the pixel columns of odd numbers and the exposure patterns formed by the pixel columns of even numbers, uneven density caused by the residual overexposure areas is smoothed by the effect of filling by the 2-overlay exposure, and becomes inconspicuous

As has been described above, according to the exposure apparatus 10 in this embodiment, uneven density and resolution caused by the error in installation angle of the exposure heads 30 and by the pattern distortion can be reduced over the entire exposure areas 32 of the respective exposure heads 30.

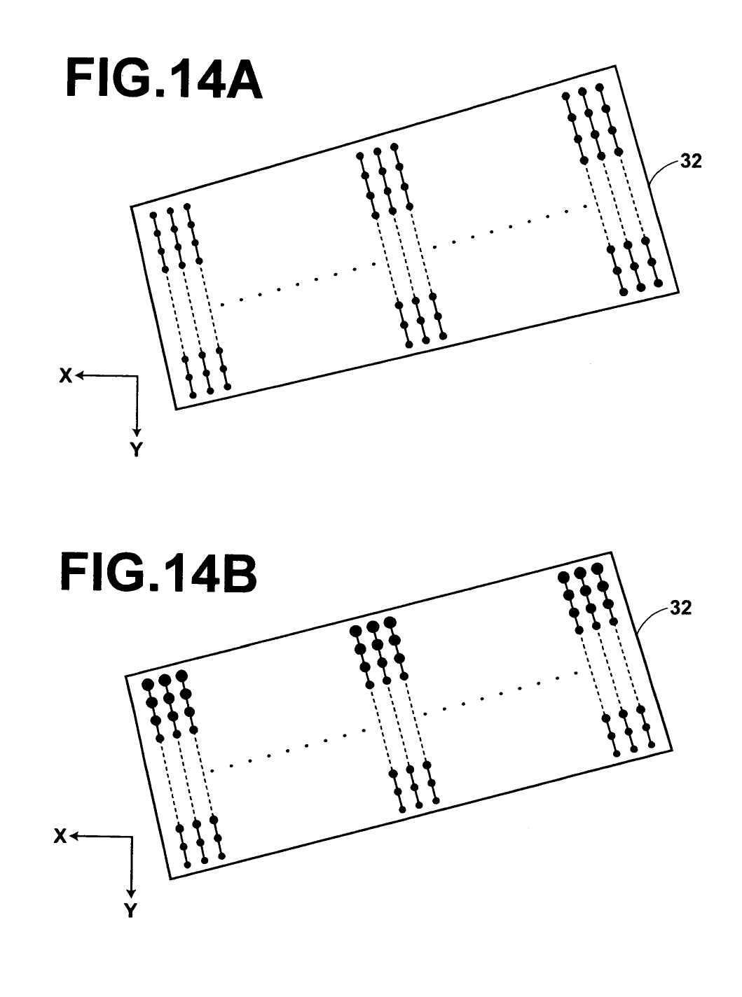

Pattern distortion that can be observed in the exposure surface may take various forms other than the angle distortion described above. For example, as shown in FIG. 14A, magnification ratio distortion is listed as one of such distortion wherein lights from the respective micro-mirrors 58 in each of the DMD's 36 reach the corresponding exposure area 32 projected onto the exposure surface with a varying magnification ratio. In addition, beam diameter distortion can also be listed wherein the lights from the respective micro-mirrors 58 in each of the DMD's 36 reach the corresponding exposure area 32 projected onto the exposure surface with a varying beam diameter, as shown in FIG. 14B. The magnification ratio distortion and the beam diameter distortion are mainly caused by various aberrations of the optical system between the DMD's 36 and the exposure surface and by deviation of alignment. Furthermore, light intensity distortion is also listed wherein the lights from the respective micro-mirrors 58 in each of the DMD 36 reach the corresponding exposure area 32 projected onto the exposure surface with a varying amount of light. This light intensity distortion is caused not only by the aberration and the alignment deviation but also by uneven light intensity due to the DMD's itself and location dependency of transmissivity of the optical elements (such as the single lens 52 and the single lens 54 in FIG. 5). The pattern distortion of these types causes the pattern formed on the exposure surface to have uneven density and resolution. However, according to the exposure apparatus 10 in the embodiment described above, residual effects of the pattern distortion of these types observed after selection of the micro-mirrors used for actual exposure can also be smoothed by the filling effect of 2-overlay exposure, as in the case of the residual effect of angle distortion described above. Therefore, according to the exposure apparatus 10 in this embodiment, uneven resolution and density caused by the pattern distortion other than the angle distortion can be reduced over the entire exposure areas 32 of the exposure heads 30.

The exposure apparatus 10 as the embodiment of the image drawing apparatus of the present invention described above in detail are merely examples, and various modifications can be made thereto within the scope of the present invention.

For example, in the embodiment described above, one of the light-spot columns projected onto the exposure surface is selected as the representative light-spot column, and the actual installation angle θ′ is measured as the angle between the scanning direction and the direction of the representative light-spot column. However, individual installation angles may be measured between the scanning direction and some of the light-spot columns from the usable micro-mirrors projected onto the exposure surface. In this case, a median, an average, a maximum, or a minimum of the individual installation angles is used as the actual installation angle so that the micro-mirrors used for actual exposure are selected according to Equation (4), for example. If the median or the average is used as the actual installation angle θ′, actual exposure can be realized in preferable balance between the overexposure part and the underexposure part. For example, the actual exposure can be carried out in such a manner that a sum of the overexposure part and the underexposure part becomes minimal and the number of the light spots in the overexposure part becomes the same as that in the underexposure part. If the maximum is used as the actual installation angle θ′, the actual exposure can be carried out with emphasis on exclusion of the overexposure part. For example, the actual exposure can be carried out in such a manner that the underexposure part becomes minimal while the overexposure part is not observed. If the minimum is used as the actual installation angle θ′, the actual exposure can be carried out with emphasis on exclusion of the underexposure part. For example, the actual exposure can be carried out in such a manner that the overexposure part becomes minimal while the underexposure part is not observed.

In addition, in the embodiment described above, the actual installation angle θ′ is found as the angle between the scanning direction and the direction of the representative light-spot column based on the positions of the two of the light spots or more in the representative light-spot column. However, the actual installation angle is not necessarily found based on the positions of the light spots in the representative light-spot column. For example, the actual installation angle θ′ may be found as an angle between position or positions of at least one of the light spots in the representative light-spot column and position or positions of at least one of the light spots in a part of the light-spot columns near the representative light-spot column. More specifically, position detection may be carried out regarding a position of one of the light spots in the representative light-spot column and a position or positions of the light spot or spots in the light-spot column or columns near the representative light-spot column placed linearly along the direction of scanning, in order to find the actual installation angle θ based on the position information. Alternatively, the actual installation angle θ′ may be an angle found according to positions of at least two of the light spots in the columns near the representative light-spot column (such as two light spots across the representative light-spot column).

In the above-described embodiment, the combinations of the slits 28 and the single cell photodetectors are used as means for detecting the positions of the light spots in the exposure surface. However, means of any other form, such as two-dimensional detector, can be used therefor.

Furthermore, in the embodiment described above, the actual installation angle θ′ is found based on the result of position detection regarding the light spots by the combinations of the slits and the photo detectors, and the active pixels have been selected based on the actual installation angle θ′. However, the usable micro-mirrors may be selected without finding the actual installation angle θ′. Furthermore, reference exposure may be carried out by using all the usable micro-mirrors, for example. Based on confirmation of unevenness in resolution and density by viewing a result of the reference exposure, for example, the micro-mirrors to be actually used may be specified manually by an operator, which is also within the scope of the present invention.

As another modification of the embodiment described above, reference exposure may be carried out by using the micro-mirrors comprising every (N−1) columns of pixels out of the usable micro-mirrors, or by using the micro-mirrors comprising a group of pixel rows that are adjacent to each other and equivalent to 1/N of all the pixel rows. In this case, the micro-mirrors that are not used for actual exposure are selected from the micro-mirrors used in the reference exposure, in order to realize a state that is close to ideal single exposure.

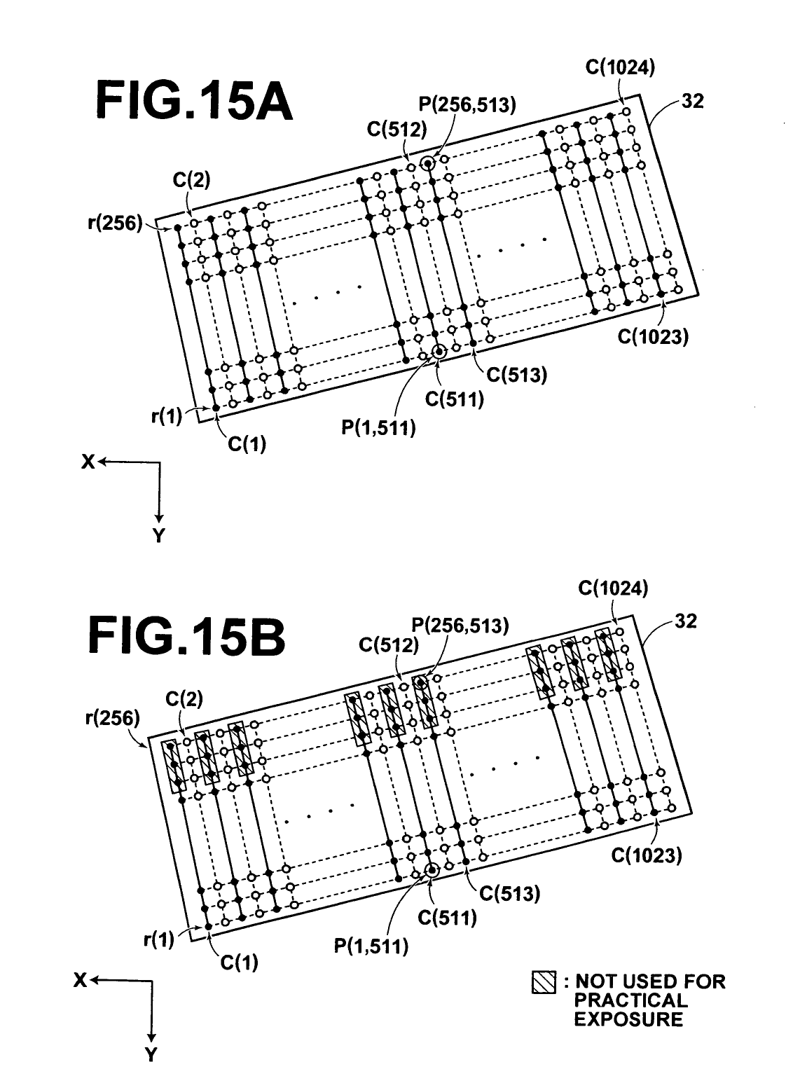

FIGS. 15A and 15B show an example of carrying out the reference exposure by using only the micro-mirrors comprising every (N−1) pixel columns. In this example, the actual exposure is 2-overlay exposure and thus N=2. The reference exposure is carried out first by using only the micro-mirrors corresponding to the light-spot columns of odd numbers shown by solid lines in FIG. 15A. A result of the reference exposure is then output. By confirming unevenness in resolution and density and inferring the actual installation angle while viewing the result of the reference exposure, an operator can specify the micro-mirrors to be used in actual exposure so that the actual exposure can be carried out with minimal unevenness in resolution and density. For example, the micro-mirrors other than the micro-mirrors corresponding to the columns of the light spots in hatched areas shown in FIG. 15B are specified as the micro-mirrors to be used in actual exposure out of the micro-mirrors comprising the pixel columns of odd numbers. For the pixel columns of even numbers, the reference exposure is carried out separately in the same manner so that the micro-mirrors to be actually used can be determined. Alternatively, the same pattern as the columns of odd numbers may be adopted therefor. By specifying the micro-mirrors to be used for actual exposure in the above manner, a state close to ideal 2-overlay exposure can be realized in actual exposure using the micro-mirrors of the columns of odd and even numbers. The result of the reference exposure may be analyzed not only by viewing but also by mechanical analysis.

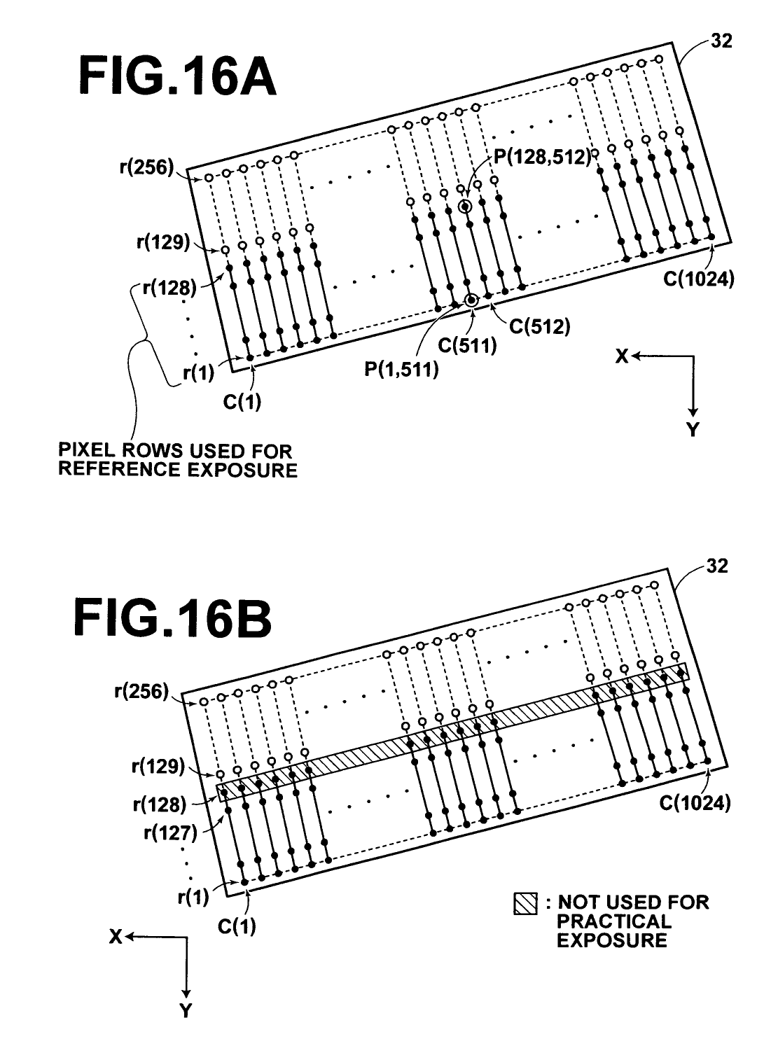

FIGS. 16A and 16B show an example of carrying out reference exposure by using only the micro-mirrors comprising the group of the adjoining pixel rows corresponding to 1/N of all the pixel rows. In this example, 2-overlay exposure is carried out and thus N=2. The reference exposure is carried out by using only the micro-mirrors corresponding to the light spots from the first row to the 128^{th} (=256/2) row shown by solid lines in FIG. 16A, and a result of the reference exposure is output. By confirming unevenness in resolution and density and inferring the actual installation angle while viewing the result of the reference exposure, an operator can specify the micro-mirrors to be used in actual exposure so that the actual exposure can be carried out with minimal unevenness in resolution and density. For example, the micro-mirrors other than the micro-mirrors corresponding to the light spots in a hatched area shown in FIG. 16B are specified as the micro-mirrors to be used in actual exposure out of the micro-mirrors from the first row to the 128^{th} row. For the micro-mirrors from the 129^{th} row to the 256^{th} row, the reference exposure may be carried out separately in the same manner to specify the micro-mirrors to be actually used. Alternatively, the same pattern as the micro-mirrors from the first row to the 128^{th} row may be adopted. By specifying the micro-mirrors to be used for actual exposure in the above manner, a state close to ideal 2-overlay exposure can be realized in actual exposure using the entire micro-mirrors. The result of the reference exposure may be analyzed not only by viewing but also by mechanical analysis.

In the above-described embodiment and the modifications thereof, the case of 2-overlay exposure in actual exposure has been described. However, any multiple-overlay exposure, that is, 2-overlay exposure or more, may be carried out. Especially, by using 3-overlay to 7-overlay exposure, exposure can be carried out in preferable balance where high resolution is maintained while unevenness in resolution and density is reduced.

It is preferable for the exposure apparatus in the embodiment and the modifications thereof to further have a mechanism for converting the image data so as to cause a size of a predetermined part in the two-dimensional pattern represented by the image data to match a size of a corresponding part of the pattern to be generated by the selected micro-mirrors. By converting the image data in such a manner, the pattern can be formed on the exposure surface with high definition as desired.

In the exposure apparatus in the embodiment and the modifications described above, the DMD's that modulate the lights from the light sources for the respective pixels are used as the pixel arrays. However, light modulators other than DMD's such as a liquid crystal array or a light-source array (an LD array or an organic EL array, for example) may be used.

The exposure apparatus in the embodiment and the modifications may carry out continuous exposure by continuously moving the exposure heads. Alternatively, the exposure apparatus may carry out exposure by moving the exposure heads in a stepwise manner to a halt for exposure.

The present invention is applied not only to the exposure apparatus and the exposure method but also to any image drawing apparatus and any image drawing method, as long as the image drawing apparatus and the image drawing method carry out N-overlay image drawing (where N is a natural number larger than 1) for generating a two-dimensional pattern represented by image data on an image drawing surface. For example, the present invention can be applied to an inkjet printer and an inkjet printing method. More specifically, a nozzle is generally formed in an inkjet recording head in an inkjet printer for propelling a droplet of ink, facing a recording medium (such as paper or an overhead projector sheet). In some inkjet printers, a plurality of such nozzles are formed in a grid-like shape, and recording heads are diagonally positioned to the direction of scanning for enabling an image to be recorded by multiple-overlay image drawing. If the present invention is applied to an inkjet printer adopting such two-dimensional arrangement and having deviation from an ideal installation angle of the heads and pattern distortion caused by an error in arrangement or the like of the nozzles, some of the nozzles whose quantity can minimize effects of the error and distortion are specified as the nozzles to be actually used. Furthermore, the effect of filling by multiple-overlay image drawing can smooth residual effects of installation angle error and pattern distortion. Therefore, uneven resolution and density can be reduced in a recorded image.

Although the embodiment of the invention and modifications thereof have been described above in detail, the embodiment and the modifications are merely examples, and it is intended that the appended claims cover all such modifications as fall within the true spirit and scope of the invention.

1. An image drawing apparatus for forming a two-dimensional pattern represented by image data on an image drawing surface by N-overlay image drawing (where N refers to a natural number larger than 1), the image drawing apparatus comprising:
one or more image drawing heads each facing the image drawing surface and comprising a pixel array having two-dimensionally placed usable pixels and generating image drawing spots for forming the two-dimensional pattern according to the image data, the image drawing head or heads being installed in such a manner that a direction of columns of the usable pixels forms a predetermined angle with a scanning direction of the image drawing head or heads;
moving means for moving the image drawing head or heads in the scanning direction relatively to the image drawing surface;
active pixel specification means for specifying, for the image drawing head or each of the image drawing heads, active pixels used for the N-overlay image drawing among the usable pixels; and
setting change means for changing a setting in order to cause only the active pixels to operate among the usable pixels, for the image drawing head or each of the image drawing heads.

2. The image drawing apparatus according to claim 1, wherein the predetermined angle, represented by 0, of the image drawing head or heads satisfies:
sp sin θ≧Nδ
where s refers to the number of pixels forming each of the columns of the usable pixels, p refers to a pitch of the usable pixels along the direction of the columns, and δ refers to a pitch of the columns of the usable pixels projected onto a line perpendicular to the scanning direction.

3. The image drawing apparatus according to claim 1, wherein the active pixel specification means specifies the active pixels for each of pixel rows.

4. The image drawing apparatus according to claim 1, wherein the active pixel specification means measures an actual installation angle formed by an actual direction of the pixel columns in the exposure surface represented by the image drawing spots and the direction of scanning, and specifies the active pixels for each of pixel rows so as to counterbalance a deviation of the actual installation angle from the predetermined angle.

5. The image drawing apparatus according to claim 4, wherein the active pixel specification means designates, as representative image-drawing spot columns, columns of the image drawing spots in the image drawing surface corresponding to a plurality of pixel columns out of the columns of the usable pixels, finds an individual actual installation angle formed by a direction of each of the representative image-drawing spot columns and the scanning direction, and specifies a representative value of the individual actual installation angles as the actual installation angle.

6. The image drawing apparatus according to claim 5, wherein representative value of the individual actual installation angels is any one of an average, a median, a maximum, and a minimum of the individual actual installation angles.

7. The image drawing apparatus according to claim 1, wherein the pixel array or arrays of the image drawing head or heads generate light spots as the image drawing spots, and the active pixel specification means comprises:
position detection means for carrying out detection of positions of the light spots in the image drawing surface for the image drawing head or each of the image drawing heads; and
selection means for finding, based on a result of the detection by the position detection means, inactive pixels among the usable pixels for the image drawing head or each of the image drawing heads in such a manner that a sum of a part wherein drawing is redundant and a part wherein drawing is deficient compared to the N-overlay image drawing in an ideal state becomes minimal in a representative area including at least one area drawn by neighboring columns of the active pixels in the image drawing surface and for selecting the pixels other than the inactive pixels as the active pixels for the image drawing head or each of the image drawing heads.

8. The image drawing apparatus according to claim 1, wherein the pixel array or arrays of the image drawing head or heads generate light spots as the image drawing spots, and the active pixel specification means comprises:
position detection means for carrying out detection of positions of the light spots in the image drawing surface for the image drawing head or each of the image drawing heads; and
selection means for finding, based on a result of the detection by the position detection means, inactive pixels among the usable pixels for the image drawing head or each of the image drawing heads in such a manner that the number of the image drawing spots in a part where drawing is redundant compared to the N-overlay image drawing in an ideal state becomes the same as the number of the image drawing spots in a part where drawing is deficient compared to the N-overlay image drawing in the ideal state in a representative area including at least one area drawn by neighboring columns of the active pixels in the image drawing surface and for selecting the pixels other than the inactive pixels as the active pixels for the image drawing head or each of the image drawing heads.

9. The image drawing apparatus according to claim 1, wherein the pixel array or arrays of the image drawing head or heads generate light spots as the image drawing spots, and the active pixel specification means comprises:
position detection means for carrying out detection of positions of the light spots in the image drawing surface for the image drawing head or each of the image drawing heads; and
selection means for finding, based on a result of the detection by the position detection means, inactive pixels among the usable pixels for the image drawing head or each of the image drawing heads in such a manner that a part wherein drawing is redundant compared to the N-overlay image drawing in an ideal state becomes minimal in a representative area including at least one area drawn by neighboring columns of the active pixels in the image drawing surface while a part wherein drawing is deficient compared to the N-overlay image drawing in the ideal state is not observed and for selecting the pixels other than the inactive pixels as the active pixels for the image drawing head or each of the image drawing heads.

10. The image drawing apparatus according to claim 1, wherein the pixel array or arrays of the image drawing head or heads generate light spots as the image drawing spots, and the active pixel specification means comprises:
position detection means for carrying out detection of positions of the light spots in the image drawing surface for the image drawing head or each of the image drawing heads; and
selection means for finding, based on a result of the detection by the position detection means, inactive pixels among the usable pixels for the image drawing head or each of the image drawing heads in such a manner that a part wherein drawing is deficient compared to the N-overlay image drawing in an ideal state becomes minimal in a representative area including at least one area drawn by neighboring columns of the active pixels in the image drawing surface while a part wherein drawing is redundant compared to the ideal N-overlay image drawing in the ideal state is not observed and for selecting the pixels other than the inactive pixels as the active pixels for the image drawing head or each of the image drawing heads.

11. The image drawing apparatus according to claim 7, wherein the inactive pixels are specified for each of pixel rows.

12. The image drawing apparatus according to claim 7, wherein the selection means finds an actual installation angle between the scanning direction and an actual direction of the pixel columns represented by the light spots projected onto the image drawing surface, based on the result of the detection regarding at least two of the light spots found by the position detection means, and finds the inactive pixels based on the actual installation angle that has been found.

13. The image drawing apparatus according to claim 12, wherein the selection means designates, as a representative light-spot column, one of columns of the light spots formed on the image drawing surface corresponding to one of the columns of the usable pixels, and finds the actual installation angle based on the result of the detection by the position detection means regarding at least two of the light spots in the representative light-spot column and the vicinity thereof.

14. The image drawing apparatus according to claim 12, wherein the selection means designates, as representative light-spot columns, a plurality of columns of the light spots in the image drawing surface corresponding to a plurality of pixel columns out of the columns of the usable pixels, finds an individual actual installation angle between the scanning direction and a direction of each of the representative light-spot columns according to the result of the detection by the position detection means regarding at least two of the light spots in the representative light-spot columns and the vicinity thereof, and finds a representative value of the individual installation angles as the actual installation angle.

15. The image drawing apparatus according to claim 14, wherein the representative value of the individual installation angles is any one of an average, a median, a maximum, and a minimum of the individual installation angles.

16. The image drawing apparatus according to claim 1, further comprising reference image drawing means for carrying out reference image drawing by using only the pixels corresponding to every (N−1) columns of the usable pixels for the image drawing head or each of the image drawing heads, in order to specify the active pixels by the active pixel specification means.

17. The image drawing apparatus according to claim 1, further comprising reference image drawing means for carrying out reference image drawing by using only the pixels comprising a group of adjoining pixel rows corresponding to 1/N of all rows of the usable pixels for the image drawing head or each of the image drawing heads, in order to specify the active pixels by the active pixel specification means.

18. The image drawing apparatus according to claim 1, further comprising data conversion means for converting the image data so as to cause a size of a predetermined portion in the two-dimensional pattern represented by the image data to match a size of a corresponding portion formed by the active pixels that have been specified.

19. The image drawing apparatus according to claim 1, wherein the pixel array or arrays are spatial light modulators for modulating light from a light source according to the image data for each of the pixels.

20. The image drawing apparatus according to claim 1, wherein the number N is a natural number ranging from 3 to 7.

21. An image drawing method using one or more image drawing heads facing an image drawing surface and each comprising a pixel array having two-dimensionally arranged usable pixels and generating image drawing spots according to image data for forming a two-dimensional pattern represented by the image data, the image drawing head or heads being installed in such a manner that a direction of columns of the usable pixels forms a predetermined angle with a direction of scanning by the image drawing head or heads, the image drawing method comprising the steps of:
specifying active pixels used for realizing N-overlay image drawing (where N is a natural number larger than 1) among the usable pixels for the image drawing head or each of the image drawing heads;
changing a setting of the image drawing head or heads so that only the active pixels to operate out of the usable pixels for the image drawing head or each of the image drawing heads; and
forming the two-dimensional pattern on the image drawing surface by causing the image drawing head or heads to operate with movement relative to the image drawing surface in the direction of scanning.
